(19) United States
(12) Patent Application Publication
(10) Pub. No.: US 2008/0318181 A1
(43) Pub. Date: Dec. 25, 2008

(54) Buccodental Hygiene Apparatus and Disposable Unit

(76) Inventor: Joseph Ohayon, Paris (FR)

Correspondence Address: BUCHANAN, INGERSOLL & ROONEY PC, POST OFFICE BOX 1404, ALEXANDRIA, VA, 22313-1404, US

(21) Appl. No.: 11/666,486

(22) PCT Filed: Oct. 28, 2005
(86) PCT No.: PCT/FR05/02713

§ 371 Date: Aug. 29, 2008

(30) Foreign Application Priority Data
Oct. 28, 2004 (FR) 0411556

(51) Int. Cl. A61C 17/02

(52) U.S. Cl. 433/80

(57) ABSTRACT

The invention concerns buccodental hygiene.

It relates to an apparatus comprising a jet cleaning device with a liquid reserve, an adjustable cannula and a hydraulic propulsion device, an evacuation device operating by suction, comprising a suction device, a liquid receptacle and an adjustable suction cannula (46), and an operation control device. At the location of the evacuation liquid receptacle, the apparatus forms a housing into which a suction orifice (22) opens out, and the evacuation liquid receptacle comprises a removable reservoir (24, 34) with a suction opening. The unit formed by the reservoir (24, 34), the tube (40) and the adjustable cannula (46) is disposable.

Application to buccodental hygiene.

The invention relates to a buccodental hygiene apparatus, and to a disposable unit intended for use with such an apparatus, particularly in a hospital environment or at home, it being possible for the apparatus to be portable and to operate from batteries or the mains.

Document WO 2004/080329 describes a buccodental hygiene apparatus comprising a jet cleaning device with a liquid reserve, an adjustable jet cannula and a hydraulic propulsion device, an evacuation device operating by suction, comprising a suction device, a liquid receptacle and an adjustable suction cannula, and a device for controlling the operation of the hydraulic propulsion device and of the suction device.

Such an apparatus therefore comprises a first reservoir, in which the reserve of the liquid used for the cleaning is placed, and a second reservoir, which is intended to receive the liquid evacuated from the patient's mouth by suction.

Such an apparatus does not pose any problems of contamination when it is used at all times by the same person. By contrast, when it is used by several persons, particularly in a hospital environment, it poses a hygiene problem due to the possibly contagious nature of certain diseases.

Moreover, document U.S. Pat. No. 4,635,621 discloses a lavage system, especially for dental use, comprising a first bag that contains the lavage liquid, and a receptacle that accommodates a second bag intended to contain the evacuated liquid. However, the configuration of this system is such that it does not guarantee complete absence of contamination when used by several persons in succession.

Moreover, document US 2003/186189 discloses a device for washing the oral cavity, comprising in particular squeezing means for improving the passage of the waste material in the evacuation tube, if necessary. The evacuation reservoir described in said document does not comprise a removable bag, and, consequently, said device is not able to avoid possible contamination between patients.

It is known in particular that nosocomial diseases pose a major health problem. The use of a hygiene apparatus that may become contaminated by a patient is a factor promoting the spread of disease. Consequently, in a hospital environment, disposable apparatus are increasingly being used. However, since a buccodental hygiene apparatus is relatively complex and expensive, it is not possible to discard it after a single use.

The invention aims to solve the aforementioned problem posed by contamination of buccodental hygiene apparatus. To this end, the invention relates to a buccodental hygiene apparatus that has a reusable part comprising all the active mechanical elements, and a disposable part comprising all the elements that may come into contact with the fluid withdrawn from a patient.

More specifically, the invention relates to a buccodental hygiene apparatus of the type comprising in combination: a jet cleaning device with a liquid reserve, an adjustable jet cannula and a hydraulic propulsion device, an evacuation device operating by suction, comprising a suction device, a liquid receptacle and an adjustable suction cannula, and a device for controlling the operation of the hydraulic propulsion device and of the suction device. According to the invention, the apparatus comprises, at the location of the evacuation liquid receptacle, a housing into which a suction orifice opens out, and the evacuation liquid receptacle comprises a removable reservoir with a suction opening.

The suction cannula is preferably connected to the removable reservoir by a tube, and the unit formed by the reservoir, the tube and the adjustable cannula is disposable.

It is advantageous that the suction device is a rotor that creates an underpressure to permit suctioning of air, giving a high flow rate of air.

The invention also relates to a disposable unit for a buccodental hygiene apparatus involving suctioning of liquid, equipped with a housing for an evacuation liquid receptacle. According to the invention, the apparatus comprises a removable reservoir with a suction opening, a tube and an adjustable cannula.

In one embodiment, the disposable unit comprises two separable elements, namely a reservoir body and an element forming lid, tube and cannula.

The element forming lid, tube and cannula preferably delimits a surface of cooperation with the reservoir body, and at least part of this surface of cooperation is intended to cooperate with a complementary surface of the body. In one variant, the complementary surface of the body and the surface of cooperation of the element cooperate via an adhesive. In another variant, the complementary surface of the body and the surface of cooperation of the element cooperate by mechanical engagement.

The reservoir body preferably has a truncated cone shape, and it can be stacked together with other similar bodies, but it can also be a disposable plastic bag.

In another variant, the reservoir body comprises a flap connected to the suction opening of the removable reservoir. This flap is preferably molded in one piece with the reservoir and has a normally closed position.

In another variant, the apparatus comprises a flap connected to that end of the tube attached to the removable reservoir. The flap is advantageously molded in one piece with the lid or with the tube, and it has a normally closed position.

Other features and advantages of the invention will be better understood on reading the following description of an illustrative embodiment, with reference being made to the attached drawings in which:

FIG. 1 is a perspective view of a buccodental hygiene apparatus according to the invention;

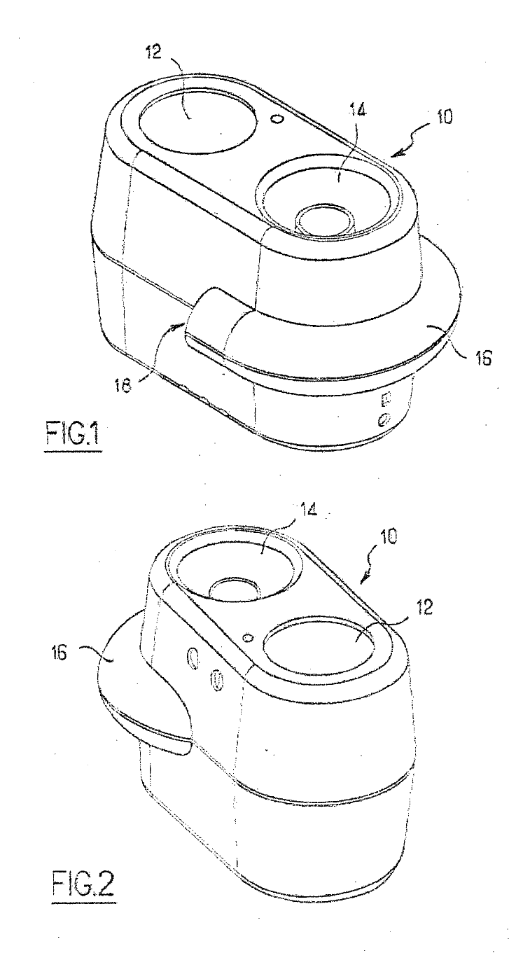

FIG. 2 is a perspective view of the apparatus from FIG. 1, seen from another side;

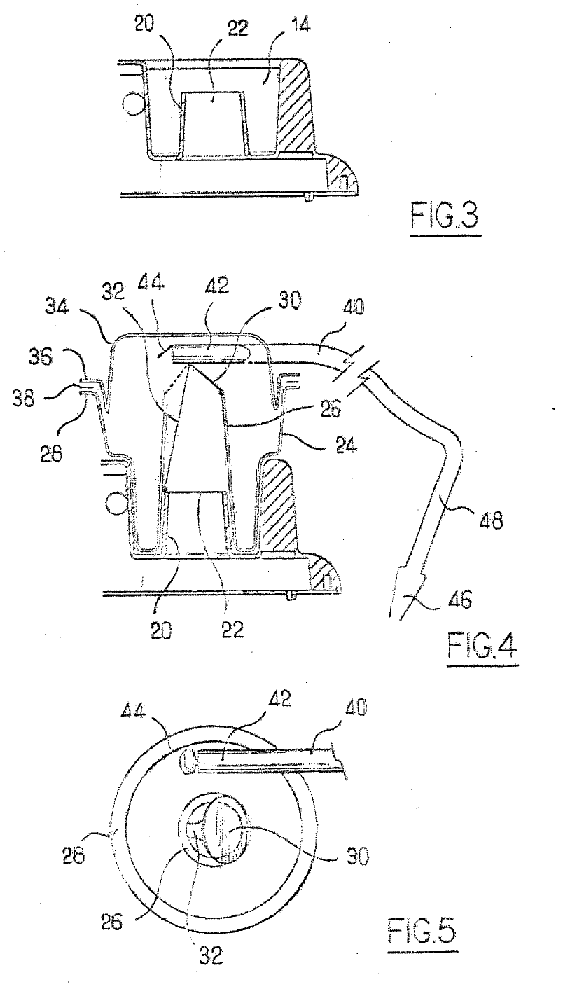

FIG. 3 is a partial cross section through a suction part of the apparatus from FIGS. 1 and 2;

FIG. 4 is a schematic cross section through a disposable unit shown cooperating with part of the apparatus from FIGS. 1 and 2; and

FIG. 5 is a schematic top view depicting characteristic elements of the device shown in FIG. 4.

FIGS. 1 and 2 depict the outer aspect of a buccodental hygiene apparatus according to the invention. This apparatus 10 comprises a first reservoir 12 intended to contain a cleaning liquid, generally water or a combination of water and various adjuvants, and a housing 14 intended for an evacuation reservoir. It will be noted that, under the housing 14, there is a widened part 16 that constitutes an outer channel of a powerful pump designed to create a considerable suction force for evacuation of fluid.

During the use of this apparatus, a cleaning liquid is placed in the reservoir 12 and is sprayed in a jet, by way of a cannula (not shown), onto the teeth and gums of the user, for example lying down.

At the same time, an evacuation cannula is placed in the lateral area of the bottom of the user's mouth in order to evacuate the liquid that has been sprayed in for cleaning. This cannula is subjected to the suction, permitting continued evacuation.

According to the invention, the apparatus not only comprises a powerful suction device, but also, in the place of the known evacuated liquid receptacle, a housing 14 which comprises, for example in its central part, a nose 20 which opens out via a suction orifice 22 to which the entire suction force of the suction device is applied.

According to the invention, this suction force is used in a disposable unit forming a liquid reservoir, tube and cannula.

An example of a disposable unit forming a liquid reservoir, tube and cannula will now be considered with reference to FIGS. 4 and 5. The unit shown here has a number of features that are not all essential and that can be used separately or in various combinations.

The disposable unit first comprises a reservoir composed of a body 24 and of a lid 34. The body 24 comprises a central tube 26. At its outer edge, it forms an orientation flange 28 that is practically horizontal (during use).

The central tube 26 ends with a flap 30 that has a normally closed position on the end of the tube 26, but that can be moved to an open position, as shown in FIGS. 4 and 5, by an arm 32 that is pushed by the nose 20 of the apparatus when the body 24 of the reservoir is introduced into the housing 14.

It will be noted that the reservoir body 24 has slightly inclined walls that permit engagement of several reservoir bodies 24 one inside another. This engagement has the advantage of allowing a batch of 10, 20 or 50 reservoir bodies 24 to be housed in a packaging article of small dimensions.

The lid 34 has a peripheral flange 36 practically adjacent and parallel to the flange 28 of the reservoir body 24 when the lid is in position on this body. The two flanges 36 and 28 are designed to be in contact when the inside of the reservoir is subjected to suction. Preferably, they are even made integral by means of an adhesive 38, which ensures leaktightness with respect to the vacuum and to the liquid.

At the upper part of the lid, a tube 40, having at one end a suction cannula 46 placed at the end of a bent part 48 facilitating positioning in a user's mouth, penetrates in a leaktight manner into the lid, in such a way that its end lies inside said lid. The figure also shows, at this end, a flap 44 that has a normally closed position and that opens under the effect of suction.

It will be noted in FIG. 5, which shows only some of the elements, that the tube 40 advantageously penetrates the side of the lid, such that the suctioned current, mainly composed of air that carries a little liquid, emerges at the edge of the lid and has a tangential movement tending to drive the liquid outward, such that it falls to the bottom of the reservoir. In this way, the liquid has no tendency to penetrate through the orifice of the tube 26.

To ensure that the liquid introduced through the tube cannot infiltrate the interface between the two flanges 28 and 36, it is advantageous that the lid forms a skirt that extends below the surface of connection of the reservoir body and its lid, as is shown in FIG. 4.

When the apparatus is to be used, the operator takes hold of the two elements of the disposable unit, that is to say the reservoir body 24 and the element forming lid 34, tube 40 and cannula 46. The two elements are brought into cooperation, for example by positioning the lid and binding it, with adhesive 38 to the flange of the reservoir body. At this moment, the unit has not yet been placed in the housing of the apparatus, although the flap 30 of the tube 26 is closed, the arm 32, which is very thin so as not to. obstruct the engagement of several reservoir bodies one inside another, lying against the inside of the wall of the tube 26. The flap 44 at the end of the tube is itself turned back to the closure position against the tube.

The operator then places the unit in the housing 14 of the apparatus, and the edge of the orifice 22, that is to say the upper part of the nose 20, pushes the arm 32, which opens the flap 30. A communication is thus established between the suction device, which does not generally function yet, and the inside of the reservoir formed by the body 24 and lid 32.

The suction device is set in operation, for example by pushing a button, and it creates an underpressure in the reservoir, such that the flap 44 opens under the effect of the underpressure and thus places the cannula 46 in communication with the inside of the reservoir. The apparatus creates a powerful suction current which, in the area of the cannula, entrains the liquid gathered at the bottom of the mouth of the user, who may be lying down. The current of fluid particularly contains air, which entrains the liquid.

When the suctioned current emerges inside the reservoir, it exits in proximity to the outer wall and follows a helical trajectory around the wall of the lid and that of the reservoir body 24. In this way, the liquid gathers toward the bottom and separates from the air. The air is suctioned through the suction opening 22 formed at the end of the tube 26, since the flap 30 is open.

When the cleaning operation is completed, the operator stops the suction device. The flap 44 at the end of the tube closes and thereby ensures that the liquid contained in the reservoir cannot return toward the cannula 46. The operator then takes hold of the reservoir 24, 34 and pulls it vertically from the housing 44. As the reservoir leaves this housing, it is not able to tilt, since it is guided by the shape of the housing 14, and the liquid cannot escape through the orifice of the tube 24. Once the reservoir has been removed by one or two centimeters, the flap 30 closes by itself, since the arm 32 no longer bears against the edge of the nose 20. At this moment, all the liquid withdrawn is enclosed in the reservoir, and the disposable unit can be discarded.

Thus, the apparatus itself is never in contact with the evacuated liquids. It therefore provides a very high degree of safety as regards the prevention of nosocomial diseases.

An elaborate embodiment has been described. Some of the described features are not essential according to the invention. For example, one or other flap can be omitted. The connection of the reservoir body to the lid can be obtained in any other way, for example by simple engagement. Since the suction device creates an underpressure in the reservoir during operation, the lid tends to remain firmly applied to the reservoir body. In addition, it is not essential for the tube 40 to emerge laterally, because it can emerge at any location in light of the fact that the evacuated liquid cannot escape through the suction orifice.

In addition, although we have shown a unit comprising two parts, on the one hand the receptacle body 24 and on the other hand the element forming lid 34, tube 40 and cannula 46, the disposable unit can be in one piece. However, it can then no longer be stacked.

The reservoir body and the element forming lid, tube and cannula are advantageously made of plastic, preferably for medical uses, given that the cannula 46 is in contact with tissues inside the user's mouth. All the elements can be formed using well known production techniques, for example by injection molding.

Thus, according to the invention, a disposable unit on the one hand comprises all the parts that are in contact with the evacuated liquid and, on the other hand, can be used by being simply positioned on the apparatus.

Instead of the rigid reservoir, which is formed by the body 24 and the lid 34 and maintains its shape in the presence of the underpressure created by the suction, it would be possible to envision using a flexible reservoir that is placed in a chamber subjected to suction. This flexible reservoir would have a shape complementing that of the housing 14 of the apparatus, so as to allow the operator to fit it easily in place in the housing 14 when the apparatus is to be used. Such a design would have the advantage of not requiring a flap, since the flexible receiving reservoir has to be entirely closed.

The flexible reservoir would in fact have to be placed in a totally closed housing to ensure that an underpressure can be created. A disposable unit would comprise, between the cannula and the flexible reservoir, a rigid lid capable of leaktight closure of a suction chamber that is sufficiently large to contain all of the flexible reservoir.

The invention is distinguished from possible designs with a flexible reservoir not only by the fact that the apparatus can be small and easy to handle, but especially by the fact that it permits circulation of a substantial flow rate sufficient to entrain the liquid.

According to another embodiment, provision can also be made for the body 24 of the rigid reservoir or the flexible reservoir to be connected to the receptacle by way of a tube designed to capture air. The housing 14 is then formed by a simple nose piece permitting engagement of the intermediate tube. This arrangement would make it possible to simplify the maneuvers performed by the operator, as the reservoir is fitted in place and removed by simple engagement and disengagement between the intermediate tube and the reservoir.

Of course, persons skilled in the art will be able to make various other modifications to the apparatus and units that have been described above solely by way of nonlimiting example, and will be able to do so without departing from the scope of the invention.

1. A buccodental hygiene apparatus comprising:
a jet cleaning device with a liquid reserve (12), an adjustable jet cannula and a hydraulic propulsion device,
an evacuation device operating by suction, comprising a suction device, a liquid receptacle, and an adjustable suction cannula (46), and a device for controlling the operation of the hydraulic propulsion device and of the suction device,
wherein the buccodental hygiene apparatus comprises, at the location of the evacuation liquid receptacle, a housing (14) into which a suction orifice (22) opens out, and the evacuation liquid receptacle comprises a removable reservoir (24, 34) with a suction opening.

2. The apparatus as claimed in claim 1, wherein the suction cannula (46) is connected to the removable reservoir (24, 34) by a tube (40), and the unit formed by the reservoir (24, 34), the tube (40) and the cannula (46) is disposable.

3. The apparatus as claimed in claim 1, wherein the suction device is a rotor that creates an underpressure to permit suctioning of air.

4. A disposable unit for a buccodental hygiene apparatus involving suctioning of liquid, equipped with a housing (14) for an evacuation liquid receptacle, comprising a removable reservoir (24, 34) with a suction opening, a tube (40) and an adjustable cannula (46).

5. The unit as claimed in claim 4, wherein the unit comprises two separable elements, namely a reservoir body (24) and an element forming lid (34), tube (40) and cannula (46).

6. The unit as claimed in claim 5, wherein the element forming lid (34), tube (40) and cannula (46) delimits a surface (36) of cooperation with the reservoir body (24), and at least part of this surface of cooperation is intended to cooperate with a complementary surface (28) of the body.

7. The unit as claimed in claim 6, wherein the complementary surface (28) of the body and the surface of cooperation of the element cooperate via a means chosen from between an adhesive (38) and a mechanical engagement.

8. The unit as claimed in claim 4, wherein the reservoir body (24) has a truncated cone shape, and it can be stacked together with other similar bodies.

9. The unit as claimed in claim 4, wherein the unit comprises a flap (30) connected to the suction opening of the removable reservoir (24, 34).

10. The unit as claimed in claim 4, wherein the unit comprises a flap (44) connected to that end of the tube (40) attached to the removable reservoir (24, 34).
